(19) United States
(12) Patent Application Publication
(10) Pub. No.: US 2023/0214885 A1
(43) Pub. Date: Jul. 6, 2023

(54) AUTOMATED, INTERNET-BASED, COMMUNICATION SYSTEM UTILIZING DIGITAL AND DIGITAL PRINT FOR BUSINESS WEBSITES

(71) Applicant: Mark Raymond Angstrom, Boca Raton, FL (US)

(72) Inventor: Mark Raymond Angstrom, Boca Raton, FL (US)

(21) Appl. No.: 17/647,276

(22) Filed: Jan. 6, 2022

(51) Int. Cl. G06Q 30/02; H04L 51/08; H04W 4/14; G06F 3/0481; G06F 3/0484

(52) U.S. Cl. CPC G06Q 30/0277; H04L 51/08; H04W 4/14; G06F 3/0481; G06F 3/0484

(57) ABSTRACT

A communication system platform that website provider is provided. The systemic platform is configured to gather information and promotional content based on a website of a website provider user. The systemic platform generates a plug-in web portal for the website and an operatively associated dashboard that the website provider can use to selectively control the data flowing in and out of the web portal. The web portal generates a two-tiered link and form website campaign for visitors, wherein the website campaign elicits visitor-specific promotional content and prompts the visitor, via the visitor-specific promotional content, to disseminate the promotional content to referral visitors.

### BACKGROUND OF THE INVENTION

The present invention relates to communication systems and, more particularly, an automated, internet-based, communication system utilizing a website dashboard, digital-only and digital and digital print campaigns utilizing links and associated forms embedded into business websites to automate communication for website visitors of website campaigns to improve customer satisfaction.

In the world of business, the name of the game is developing customer sales and converting customer sales to business revenue. Customer sales and business revenue are earned through an organization's systematic contact and development of solutions for customers. Website visitation for product and/or service content to trigger future purchases or to communicate product and/or service content to others is expected. Companies are, however, frequently unable to effectively, efficiently, sustainably deliver product and/or service content on an efficient, effective, and sustainable method to support customer satisfaction and development.

Customers require contact and solution-based content to support business improvement, which is what a website visitor is looking for when perusing a business website. Business website automation delivers automatic content and contact on behalf of a business, thereby improving customer satisfaction.

Present systems rely on individuals viewing static business websites to communicate business product and services efficiently, effectively, and sustainably. The internet, business websites, and automation today support efficient, effective, and sustainable communication to improve customer satisfaction through website automation.

There is a need for an automated, internet-based, communication system that business website providers can implement to improve customer satisfaction and customer sales conversion, thereby automating promotional content delivery and contact via the business website. The communication system embodied in the present invention configures a dashboard for the website through which the website provider establishes the promotional communication generated by website campaigns incorporating links and associated forms.

In certain embodiments, the website may provide business website visitors with digital or digital and digital print communications, to deliver solution-based content. For instance, the present invention enables website visitors to register and communicate their interest via an automated, personalized, website campaign incorporating links and associated forms. The website campaign (links and associated form) generated by the system and embedded into the business website is configured to enable business websites to communicate automatically, and frequently, with interested website visitors and those in their social media circle.

In sum, the present invention facilitates an “ATM (Automatic Teller Machines) Society” through the website dashboard communication system providing website automation and streamlined business communication, wherein the communication is configured to support convenient business solutions. The communication is automated and delivered effectively and efficiently, including marketing literature automatically delivered in the form of digital and digital print product content. Improving business communication and frequency in the marketplace.

### SUMMARY OF THE INVENTION

In one aspect of the present invention, a method for establishing a communication system for a website, the method includes the following: providing, through a systemic server, an online platform, wherein the platform is configured to operatively associate a website campaign with the website; inputting into the online platform, via a provider computer, website data for the website, wherein the website data comprises at least one promotional content; compiling, by way of the systemic server, the website campaign embodying the at least one promotional content; offering, by way of the systemic server, a test drive service to the provider computer, wherein the test drive service presents the website campaign on a user interface of the provider computer, and wherein the test drive service prompts the providers computer to accept the website campaign; and configuring by way of the systemic server, upon acceptance by the provider computer, a dashboard on the provider computer, wherein the dashboard is configured to modify the website campaign.

In another aspect of the present invention, the method for establishing a communication system for a website further includes the following: operatively associating, by way of the systemic server, the website campaign with the website, wherein the website campaign comprises a test drive campaign and a system campaign, wherein the test drive campaign comprises digital only communication, wherein the system campaign comprises the test drive campaign and a physical postcard delivery, wherein the test drive campaign comprises three electronic communication messages comprising an SMS text message and a first and second email, wherein the first email includes a PDF attachment, and wherein the second email is transmitted twenty-four hours after the first email is transmitted, wherein the second email has no file attachment, wherein the SMS text message is transmitted seventy-two hours after the first email, wherein the website campaign prompts a visitor computer for an email address, a cellular phone number, and a physical address, wherein the first and second emails are transmitted to the email address, wherein the SMS text message is transmitted to the cellular phone number, and wherein the physical postcard is delivered to the physical address.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention.

FIG. 2 is a flow chart of an exemplary embodiment of the present invention.

FIG. 3 is a flow chart of an exemplary embodiment of the present invention.

FIG. 4 is a flow chart of an exemplary embodiment of the present invention.

FIG. 5 is a block diagram of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a communication system platform that website provider can access, wherein the systemic platform is configured to gather information and promotional content based on a website of the website provider. The systemic platform generates a plug-in campaign incorporating links and associated forms for the website from an operatively associated dashboard that the website provider can use to establish the data flowing in and out of the website. The web dashboard generates a website campaign for visitors, wherein the website campaign elicits specific promotional content and prompts the visitor to consider the website providers produce or service.

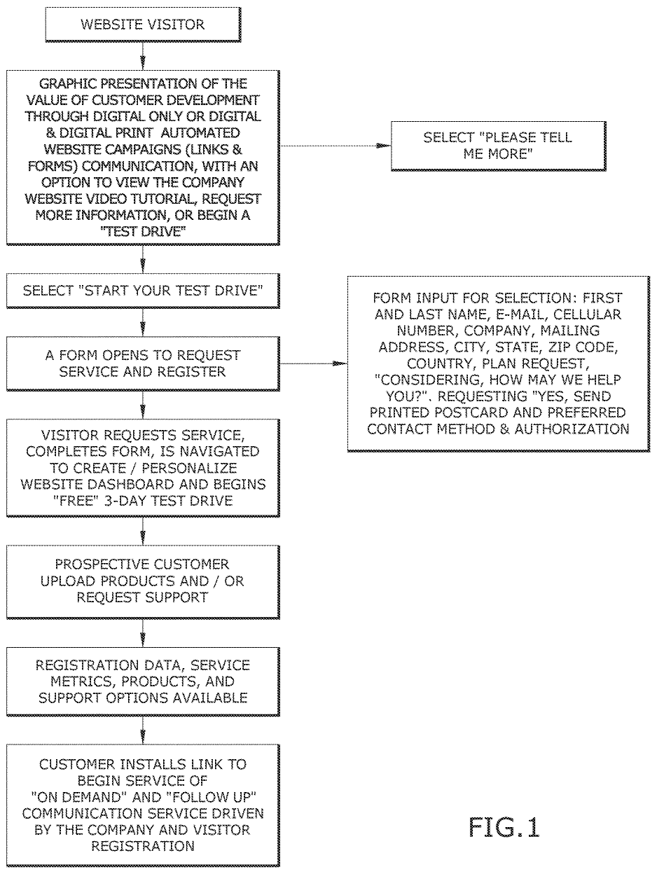

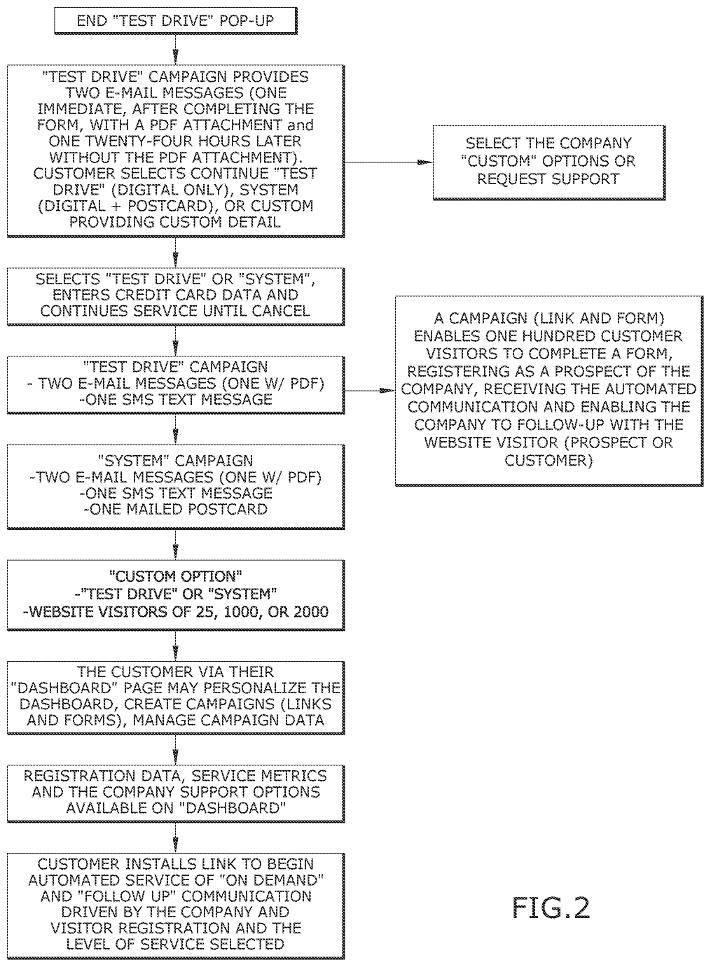

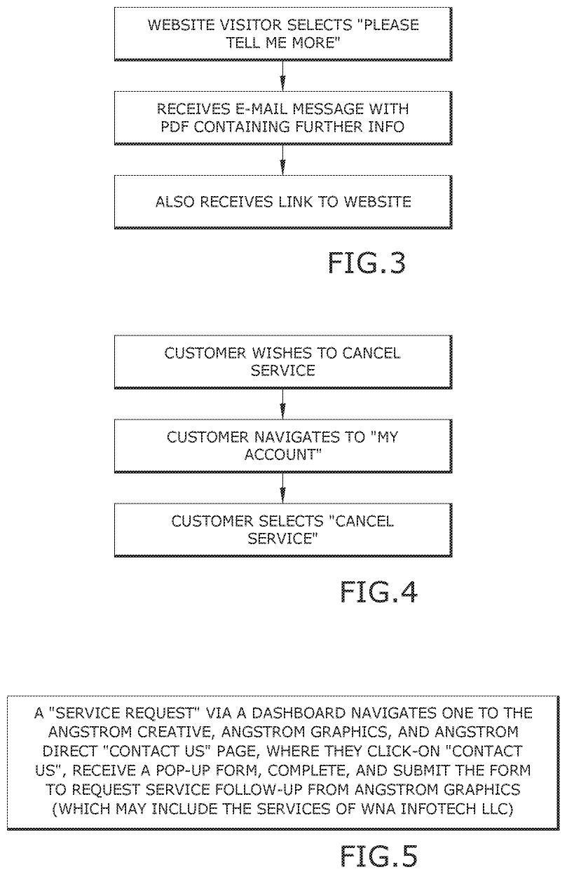

Referring now to FIGS. 1 through 5, the present invention may include a communication system embodied in an online platform for a website provider, wherein the website provider has a website that the communication system can be operatively associated with. The communication system enables a dashboard for the website provider to establish one or more website campaigns through a web campaign incorporating links and associated forms plugged into the website, whereby visitors to the website are delivered promotional content through the web campaign incorporating links and associated form and receive follow-up communication from the website provider by email, SMS text message, and mailed postcard (if selected).

A website provider may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser when interacting with the online platform and/or network of computing devices and/or server(s). The computer may access the software via the web browser using the internet, extranet, intranet, host server, internet cloud and the like.

The online platform of the communication system may be a website operatively associated with a systemic server. A user of the present invention may be a website provider having administrative control over a provider website independent of the systemic online platform. Upon a provider visitation of the systemic online platform, the systemic server may provide to the website provider via a graphic presentation via their computer user interface, a value of customer development through selective deployment of systemic website campaign communication. The website provider may also be presented with an option to view the company website tutorial, request more information (“please tell me more”), or begin a test drive service.

When the user selects “start your test drive”, their user interface requests service and registration. Here, the website provider user is prompted to input website provider information. Website provider information may include but not limited to, first and last name, email, cellular number, company, mailing address, city, state, zip code, country, plan request, preferred contacts, and the like. The website information may be gathered through specific prompts; for instance, prompts such as “how may we help you?”.

Once the website provider information is collected, the website provider requests a service and may be prompted to provide website data. Website offerings include products or services offered through the website of the website provider.

The systemic server processes the website provider information in combination with the website data to create or personalize a website dashboard. The website dashboard is configured to manage registration data of visitors of the website and generate service metrics, products, and support options resulting from visitor interactions with the provider website.

The website dashboard is configured to enable the website provider to establish website campaigns and its constituent promotional communication services exportable from their website by way of a website campaigns. The promotional communication services may include installation of campaigns (links and associated forms) for the website to begin services of “on demand” and “follow up” promotional communication driven by the website dashboard campaigns and visitor data collected through an initial promotional communication service intake. The website provider may begin a test drive through the online platform, wherein the website is enabled with the functionality of the website dashboard and a Test Drive Campaign can be generated through the website dashboard for 25 website visitors (depending on number of campaigns generated).

### Website Campaigns

The promotional communication service intake includes prompting a visitor to the website to “test drive” the website campaign, which includes the test drive campaign incorporating links and associated form enabled by the systemic dashboard. Upon activation of the Test Drive Campaign, via the web portal enabled by the systemic server, the present invention provides three (3) electronic communication messages. The three (3) electronic communication messages are two emails (the first immediately with a file attachment (e.g., PDF attachment) and second 24 hours later without the file attachment) and a SMS text message (72 hours later). The first electronic communication message sent immediately, after the visitor completes a form that collects visitor information. The first electronic communication delivered with, in certain embodiments, a PDF file attachment of promotional content that was uploaded to the website dashboard. The second electronic communication message is transmitted 24 hours later without a file attachment or link, and the SMS text message may be delivered 72 hours later to remind the website visitor of their initial visit to the website campaign and providers website. It is understood that the time periods mentioned above are exemplary and can be selectively adjusted by the user—i.e., 72 hours could be 36 hours, etc., and 24 hours could be 12 hours. Likewise, the file attachment could be another form of attachment besides a PDF attachment, such as a power point attachment, word document, spreadsheet or image, audio, or video attachment. Similarly, the postcard referenced herein could be a multi-page flyer or brochure. The present invention contemplates more than email and SMS text messages as the forms of electronic communication, and thus lists those merely as examples.

The website provider is prompted following the Test Drive Period (e.g., 3 days) and may select to continue the Test Drive Campaign ‘only digitally’ or select an upgrade to System Campaign (digital and a mailed postcard), the visitor may also select “custom” options or request support.

The promotional communication service (Test Drive Campaign) initially includes a campaign incorporating links and associated forms capable of enabling twenty-five visitors to a campaign (or 12 per two campaigns, etc.). An agreement to continue a Test Drive Campaign or upgrade to System Campaign, enables one hundred customer visitors to the campaign (links and associate form) or 50 to two (2) campaigns, etc., registering the website visitor on the provider dashboard and automatically communicating, as described above. This website visitor may refer other visitors to the provider website via either the Test Drive Campaign or the System Campaign. The website visitor will, via the computer, receive the automated communication, which in turn enables the provider to follow-up with the visitor.

The website provider, through their computer, may enter credit card data to continues transmission of promotional communication via the Test Drive or System Campaigns to website visitors until cancelation.

The provider via their website dashboard may personalize the website dashboard, generate, and update website campaigns, including reconfiguring the campaigns (link/s and associated form) as well as manage campaign data. Registration data, service metrics and a plurality of company support options are also provided to the website provider through the dashboard. Additional “on demand” and “follow up” communication campaigns may be produced by the company, visitor registration and level of service selected, on the company's dashboard.

If a website visitor selects “please tell me more”, they receive an e-mail message with a file containing further information as well as the promotional communication service links. Visitors can cancel services, navigate their registration account, review their website visitor data on their website dashboard.

In an exemplary embodiment, the present invention includes the online platform, https://www.angstrompod.com, which presents on the user interface of the user computer a representation of a system video and options to select test drive, system, or custom solution options. In addition to the subject matter disclosed above, the online platform may be configured to provide necessary input, receive a dashboard, and begin a Test Drive Campaign of twenty-five (25) website visitors for a business website. The online platform may be configured to generate and insert a campaign (link/s and associated form) to a company website and determine communication products for each. As a result, the online platform (website) visitors request communication products and follow-up communication.

Visitor campaigns enable company communication to become automated, delivered conveniently, efficiently, and effectively. Visitor-enabled promotional communication further enables referrals too quickly build business and grow an established presence.

The present invention enables businesses to purchase and implement an automated communication service for the business website through which they can communicate efficiently, effectively, and sustainably via digital and digital print services automatically from the business website. Personalization and scheduling frequent communication is established through a systemic website dashboard.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example and not by way of limitation, an user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-Fl network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-Fl network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

The computer-based communication system and method described above is for purposes of example only and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for establishing a communication system for a website, the method comprising:
providing, through a systemic server, an online platform, wherein the platform is configured to operatively associate a website campaign with the website;
inputting into the online platform, via a provider computer, website data for the website, wherein the website data comprises at least one promotional content;
compiling, by way of the systemic server, the website campaign embodying the at least one promotional content;
offering, by way of the systemic server, a test drive service to the provider computer, wherein the test drive service presents the website campaign on a user interface of the provider computer, and wherein the test drive service prompts the providers computer to accept the website campaign; and
configuring by way of the systemic server, upon acceptance by the provider computer, a dashboard on the provider computer, wherein the dashboard is configured to modify the website campaign.

2. The method of claim 1, further including operatively associating, by way of the systemic server, the website campaign with the website.

3. The method of claim 2, wherein the website campaign comprises a test drive campaign and a system campaign.

4. The method of claim 3, wherein the test drive campaign comprises digital only communication.

5. The method of claim 4, wherein the system campaign comprises the test drive campaign and a physical postcard delivery.

6. The method of claim 5, wherein the test drive campaign comprises three electronic communication messages, the three electronic communication messages comprising an SMS text message and a first and second email, wherein the first email includes a file attachment, and wherein the second email is transmitted twenty-four hours after the first email is transmitted.

7. The method of claim 6, wherein the second email has no file attachment.

8. The method of claim 7, wherein the SMS text message is transmitted seventy-two hours after the first email.

9. The method of claim 8, wherein the website campaign prompts a visitor computer for an email address, a cellular phone number, and a physical address.

10. The method of claim 9, wherein the first and second emails are transmitted to the email address, wherein the SMS text message is transmitted to the cellular phone number, and wherein the physical postcard is delivered to the physical address.

11. The method of claim 10, wherein the file attachment is a PDF attachment.
